(19) United States
(12) Patent Application Publication
(10) Pub. No.: US 2026/0214762 A1
(43) Pub. Date: Jul. 23, 2026

(54) MOLD MAT, MOLD AND METHOD OF PRODUCING SUCH

(71) Applicant: Dragos DANCILA, Uppsala (SE)

(72) Inventor: Dragos DANCILA, Uppsala (SE)

(21) Appl. No.: 19/141,384

(22) PCT Filed: Dec. 21, 2023
(86) PCT No.: PCT/SE2023/051294

§ 371 Date: Jun. 20, 2025

(30) Foreign Application Priority Data
Dec. 23, 2022 (SE) 2251570-4

(51) Int. Cl. H05B 6/64; C08J 5/24; C09D 5/24; H01M 4/04; H01M 4/131

(52) U.S. Cl. CPC H05B 6/6491; C08J 5/243; C09D 5/24; H01M 4/0404; H01M 4/131

(57) ABSTRACT

Microwave heating technology for manufacturing of composite materials with a particular emphasis on materials that exhibit electrical conductivity is provided. In particular, a flexible mold mat and a mold including resonant electromagnetic structures and a method of producing a mold and a method of using a mold including resonant electromagnetic structures to produce composite products. The flexible mold mat includes a plurality of layers and a curable substance. At least one layer includes a flexible base material and a plurality of flexible electromagnetic resonant structures positioned on the base material.

### TECHNICAL FIELD

The present invention relates to microwave heating technology for manufacturing of composite materials with a particular emphasis on materials that exhibit electrical conductivity. In particular, the present invention relates to a mold mat and a mold comprising resonant electromagnetic structures and a method of producing a mold and a method of using a mold comprising resonant electromagnetic structures to produce composite products, and dry and produce battery electrodes.

### BACKGROUND

Fibre-reinforced polymer materials are increasingly important in many areas of technology. For the most demanding applications carbon fiber-reinforced polymers is the most important product category due to its extraordinary strength compared to its weight. Carbon fiber-reinforced polymers may also be referred to as carbon-fiber-reinforced plastics (CFRP), or carbon-fiber reinforced-thermoplastic (CFRTP), or more prosaic as “carbon fiber”, “carbon fiber composite”, “carbon composite”, or just “carbon”. Despite the high costs of production, carbon fiber composites are commonly used wherever high strength-to-weight ratio and stiffness (rigidity) are required, such as aerospace, ships, automotive, civil engineering and sports equipment. The binding polymer is often a thermoset resin, such as epoxy, but also other thermoset or thermoplastic polymers, such as polyester, vinyl ester, polyether ether ketone (PEEK), or nylon, are sometimes used. Various additives may be used, both additives effecting the properties of the binding polymer and additives complementing the fiber-part, such as graphene flakes and nanotubes or other types of fibers, both inorganic and organic.

Today, the most widespread industrial scale production method of carbon fiber composite products includes using a plurality of carbon fiber material layers that is already impregnated with resin (pre-preg). The stack of layers is applied to a mold and the assembly is then placed in an autoclave, which provides over pressure and heat for the curing process. The production method is well established and can produce carbon fiber composite products of high quality. However, the method is costly-large autoclaves represent large investments, the process of obtaining pressure and heat is time and energy consuming and probably most importantly, the process is limited by the uniformity of heating especially for large items, relying on the homogeneity of the circulating air temperature in the autoclave. The production costs at this step are main reasons for the carbon fiber composite products still being expensive despite that today the costs for the separate materials by themselves are relatively low. This hinders a widespread use carbon fiber composite products.

During recent years alternatives to the costly autoclave-based production methods have emerged. Production techniques not using autoclaves are consequently referred to as “out of autoclave” (OOA). One approach is to provide heating by microwave technology exemplified with the product HEPHAISTOS developed by Vötsch Industrietechnik GmbH, https://www.weiss-technik.com/en/products/produkte-detail/vhm-hephaistos-patented-microwave-technology. Another example is induction heating as developed by Corebon AB, wherein heat is generated by ohmic losses, i.e., by currents induced in the carbon fiber conductive fibers, https://corebon.com/our-technology.

A way to localize heating to the carbon fiber composite layer stack is to use a microwave source and resonant elements that are provided in contact, or close to, the carbon fiber composite layer stack. WO 2020/056793 discloses a microwave curing method for multi-directional laminated carbon fiber reinforced resin-based composite material that comprises placing an array of three-dimensional (3D) metal units on the surface of the carbon fiber reinforced resin-based composite material or within a certain range from the surface, and subjecting the 3D metal units to microwaves of a frequency that will resonate and cause heating of the 3D metal units. WO 2017/017235 discloses a method and device also utilizing microwave resonance as the principle for heating. In this case the resonant elements are dielectric resonators, i.e., with boundary conditions of high impedance, which are realized by shaping, in a puck form, a material that is permeable to high-frequency electromagnetic radiation and characterized by a high dielectric constant. In addition, in WO 2017/017235, this puck is placed in a resonant chamber of the housing which is arranged between the coupling-in means and a molded part to be heated.

### SUMMARY

The object of the present invention is to overcome the drawbacks associated with prior art techniques manufacturing of composite materials, with a particular emphasis on materials that exhibit electrical conductivity. This is achieved by a flexible mold mat, a mold, a method of forming a mold, a method of curing a carbon fiber composite object, a device for method of curing a carbon fiber composite object and a method for drying and producing a battery electrode defined by the independent claims.

Further embodiments of the present invention are defined in the dependent claims.

An aspect of the invention relates to a flexible mold mat. The flexible mold mat comprises a plurality of layers and a curable substance. At least one layer of the plurality of layers comprises a flexible base material and a plurality of flexible resonant electromagnetic structures positioned on the base material. The flexible resonant electromagnetic structures are electrically insulated from each other.

According to one embodiment of the invention, the flexible resonant electromagnetic structures each has a thickness in a range of 0.1% to 10% of the thickness of the flexible mold mat.

According to one embodiment of the invention, the flexible resonant electromagnetic structures are patches of a conductive material, and the at least one layer comprising the patches is non-conducting. According to one embodiment of the invention, the flexible resonant electromagnetic structures have a stiffness that is less than 1.5 times the stiffness of the flexible base material, preferably less than 1.25 times the stiffness of the flexible base material and even more preferably less than 1.1 times the stiffness of the flexible base material.

According to one embodiment of the invention, the plurality of layers of the flexible mold mat forms a multilayered structure. In such an embodiment, the flexible resonant electromagnetic structures each has a stiffness that is less than 1.3 times the stiffness of the multilayered structure, preferably less than 1.2 times the stiffness of the multilayered structure and even more preferably less than 1.1 times the stiffness of the multilayered structure.

According to one embodiment of the invention, the flexible resonant structures comprise a carbon fiber material. In such an embodiment, the carbon fiber material being the main constituent of the flexible resonant electromagnetic structures.

According to one embodiment of the invention, the flexible resonant electromagnetic structures are thin metal films or metallic wires.

According to one embodiment of the invention, the conductivity of the flexible resonant electromagnetic structures is above 1 S/m, preferably above 10² S/m.

According to one embodiment of the invention, the flexible resonant electromagnetic structures are dielectric resonators of a material that is permeable to high-frequency electromagnetic radiation. In such an embodiment, the dielectric resonators are placed in direct contact with the flexible base material.

According to one embodiment of the invention, the flexible resonant electromagnetic structures are arranged in a 2D regular pattern.

According to one embodiment of the invention, the 2D regular pattern is adapted to be used in a frequency range of 2.4-2.5 GHz and individual flexible resonant electromagnetic structures are 30 mm in width and length with a thickness of 17.5 μm (½ oz) or 35 μm (1 oz). The 2D regular pattern is a succession of gaps and rectangular patch structures.

According to one embodiment of the invention, the 2D regular pattern of the plurality of layers of the flexible mold mat form a multilayered structure. In such an embodiment, the 2D regular pattern of the flexible resonant electromagnetic structures are placed on both the upper half and bottom half of the multilayered structure.

According to one embodiment of the invention, the flexible resonant electromagnetic structures are arranged in a 3D regular pattern.

Another aspect of the invention relates to a mold for heating and curing a carbon fiber composite object. The mold comprises a plurality of flexible resonant electromagnetic structures. The mold is at least partly made from a flexible mold mat described above.

A further aspect of the invention relates to a method of forming a mold. The method comprises providing a flexible mold mat described above, forming the flexible mold mat into a predefined shape, and curing the flexible mold mat and thereby forming a rigid mold.

According to one embodiment, the formed rigid mold comprises the flexible resonant electromagnetic structures.

Yet another aspect of the invention relates to a method of curing a carbon fiber composite object. The method comprises providing a mold as described above, placing an uncured carbon fiber composite object into the mold, and heating the uncured carbon fiber composite object by providing microwave radiation of a predetermined frequency from a microwave radiation source to the plurality of flexible resonant electromagnetic structures. The predetermined frequency and the characteristics of the plurality of flexible resonant electromagnetic structures are matched so that the flexible resonant electromagnetic structures generate heat, thereby curing the uncured carbon fiber composite object to form a rigid carbon fiber composite object.

According to one embodiment of the invention, the method comprises curing the uncured carbon fiber composite object in a continuous process by continuously activating portions of the plurality of the flexible resonant electromagnetic structures by microwave radiation from the microwave radiation source.

According to one embodiment of the invention, the method comprises applying pressure to the heated carbon fiber composite object.

According to one embodiment of the invention, the pressure is applied by a consolidation roller, which is arranged to pressure the heated carbon fiber composite object with a predetermined force and to move over the heated carbon fiber composite object in a predetermined direction.

According to one embodiment of the invention, the consolidation roller comprises the microwave radiation source so that a portion of the plurality of flexible resonant electromagnetic structures are activated so that the uncured carbon fiber composite object is simultaneously exposed to localized heat and pressure from the consolidation roller.

Another aspect of the invention relates to a device for curing a carbon fiber composite object. The device comprises a mold according to above and a consolidation roller comprising a microwave radiation source and arranged to simultaneously provide localized pressure to the carbon fiber composite object and localized heat by the microwave radiation source activating a portion of the plurality of flexible resonant electromagnetic structures.

Yet another aspect of the invention relates to a method for producing a battery electrode. The method comprises depositing a battery slurry comprising an active material, a conductive additive, a polymer adjuvant and a solvent onto an electrode foil to form a slurry coating. The method also comprises positioning a mold according to the invention in proximity with the slurry coating and heating the slurry coating on the electrode foil to remove solvent from the slurry coating by providing microwave radiation of a predetermined frequency from a microwave radiation source to the plurality of flexible resonant electromagnetic structures. The predetermined frequency and the characteristics of the plurality of flexible resonant electromagnetic structures are matched so that the plurality of flexible resonant electromagnetic structures generates heat in the slurry coating, thereby drying the slurry coating on the electrode foil to form a battery electrode.

Thanks to the invention, molds of complex shapes may be fabricated and composite materials manufactured with high accuracy and at low costs compared to with existing technology.

Thus, the present invention provides a fast, automatized, inexpensive method to realize the mold mat, and producing such mold mats by including flexible resonant electromagnetic structures, such as conductive resonant elements or dielectric elements, as dielectric resonators in this mold mats and in the molds produced from such mold mats.

Many additional benefits and advantages of the present invention will be readily understood by the skilled person in view of the detailed description below and accompanying drawings.

### DRAWINGS

The invention will now be described in more detail with reference to the appended drawings, wherein FIGS. 1a-c schematically illustrate embodiments of the flexible mold mat according to the invention in 1a) a first embodiment in an elevated perspective view, 1b) the first embodiment in a cross-sectional side view, and 1c) a second embodiment in elevated perspective view;

FIGS. 2a-b schematically illustrate two embodiments of the flexible mold mat according to the invention, wherein 2a) flexible resonant electromagnetic structures are provided in a regular 2D pattern and 2b) flexible resonant electromagnetic structures are provided in a 3D arrangement;

FIGS. 3a-b 3a) is a graph of the reflection coefficient, S11, showing the resonance frequency of the patches placed on top of the conductive layer for different embodiments of the invention and 3b) is a graph illustrating the heat produced with flexible resonant electromagnetic structures arranged in a 2D pattern;

FIGS. 4a-c 4a) schematically illustrates a mold according to an embodiment of the invention in a cross-sectional side view, 4b) schematically illustrates the mold with more details on dimensions and 4c) shows two molds on each side of a carbon fiber composite;

FIG. 5 illustrates one embodiment of the method of production according to the invention using a roller to apply a pressure to consolidate a carbon composite product;

FIG. 6 illustrates a flow chart of method of forming a mold according to an embodiment;

FIG. 7 illustrates a flow chart of a method of curing a carbon fiber composite object according to an embodiment;

FIGS. 8a-b illustrate processes of forming a slurry coating on an electrode substrate;

FIG. 9 illustrates a process of heating the slurry coating to remove solvent from the slurry coating; and

FIG. 10 illustrates a flow chart of a method for producing a battery electrode.

All the figures are schematics, not necessarily to scale, and generally only show parts, which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

Terms such as “top”, “bottom”, “upper”, “lower”, “below”, “above” etc. are used merely with reference to the geometry of the embodiment of the invention shown in the drawings and/or during normal operation or mounting of the device/devices and are not intended to limit the invention in any manner.

The flexible mold mat 100 according to the invention is schematically illustrated in FIGS. 1a-b, wherein FIG. 1a is an elevated perspective view, and FIG. 1b is a cross-sectional side view. The flexible mold mat 100 comprises a plurality of flexible layers 110 and a curable substance 120. At least one layer 111 of the plurality of layers 110, denoted base layer 111 herein, comprises a flexible base material and a plurality of flexible resonant electromagnetic structures 130. The flexible resonant electromagnetic structures 130 are electrically insulated from each other.

In an embodiment, the flexible resonant electromagnetic structures 130 are positioned on or in the base material. The flexible resonant electromagnetic structures 130 are positioned with a distance in between individual flexible resonant electromagnetic structures and are thereby electrically insulated from each other. This at least one layer 111 will preferably be in direct contact with the carbon fiber composites.

The layers 110 of the mold mat 100 are typically flexible and preferably made of cloth-like material, such as woven or non-woven glass fiber with a weight typically in the range of 50-500 g/m². The mold mat 100 may comprise layers 110 of only one type, for example woven glass fiber of the same type and weight or layers 110 of different type and weight. For example, the mold mat 100 may comprise a layer of woven glass fiber and a layer of woven carbon fiber. Also, other types of fibers, inorganic as well as organic may be utilized in the mold mat 100, for example various types of textile fibers, KAPTON@ foil, TEFLON® foil, etc.

The curable substance 120 is for illustrative purposes depicted as a separate layer. However, typically and preferably, the curable substance 120 is at least in part incorporated in the layers 110. This may be realized by utilizing layers 110 that have been pretreated with the curable substance 120, often referred to as pre-preg glass or carbon fiber. The curable substance 120 may be a binding polymer, such as thermoset resin, most commonly epoxy, but other thermoset or thermoplastic polymers, such as polyester, vinyl ester, or nylon may be utilized.

The purpose of the flexible resonant electromagnetic structures 130 is to couple to an applied electromagnetic field with a specific wavelength in the microwave region and resonate considering the distance to the plate of carbon fiber material, on top of which these flexible resonant electromagnetic structures 130, such as in the form of patches, are placed. The flexible resonant electromagnetic structures 130 may therefore be regarded as microwave resonant thin film antennas.

The lateral dimensions of the patches as well as the distance to the plate contribute to the resonance frequency of the flexible resonant electromagnetic structures 130. The flexible resonant electromagnetic structures 130 are therefore made of a conductive material, i.e., with a conductivity above 1 S/m and preferably above 102 S/m. The flexible resonant electromagnetic structures 130 should preferably be arranged to resonate with microwave electromagnetic radiation in a given frequency range, which are usually industrial, scientific, and medical (ISM) bands, i.e., 902 to 928 MHz, 2.4 to 2.5 GHz and 5.725 to 5.875 GHz to give few illustrative, but non-limiting, examples.

According to one embodiment, the flexible resonant electromagnetic structures 130 are thin metal films, for example but not limited to, films of gold, silver, copper, aluminum, tin or alloys or composites of these metals.

According to one embodiment, the flexible resonant electromagnetic structures 130 are patches of a conductive fabric.

According to one embodiment, the conductive fabric comprises mainly carbon fibers. The conductive fabric of carbon fibers may be in the form of a weave or a stitched structure. Alternatively, the carbon fibers may be randomly, or pseudo-randomly, oriented, providing a non-woven carbon fabric.

According to one embodiment, the conductive fabric comprises mainly metal wires for example but not limited to, wires of gold, silver, copper, aluminum, tin or alloys or composites of these metals. The conductive fabric of metal wires may be in the form of weave or a stitched structure.

In an embodiment, the flexible resonant electromagnetic structures 130 are in form of a thin conducting material. Hence, the flexible resonant electromagnetic structures 130 may be described as flexible patch antennas, in particular microwave resonant thin film antennas.

The flexible resonant electromagnetic structures 130 may be provided on the flexible base material of the at least one layer 111 as depicted in FIGS. 1a-b, for example with an adhesive or glue. Alternatively, according to embodiments of the invention, the flexible resonant electromagnetic structures 130 may be incorporated in the flexible base material of the at least one layer 111, for example weaved into flexible base material or embroidered to the flexible base material, particularly if the flexible base material is a weave. The flexible resonant electromagnetic structures 130 may additionally incorporated in thin films, such as printed or etched thin films. The flexible resonant electromagnetic structures 130 may be incorporated in different printed circuit board (PCB) manufacturing techniques and as such be incorporated in PCBs. The flexible base material of the at least one layer 111 is electrically insulating.

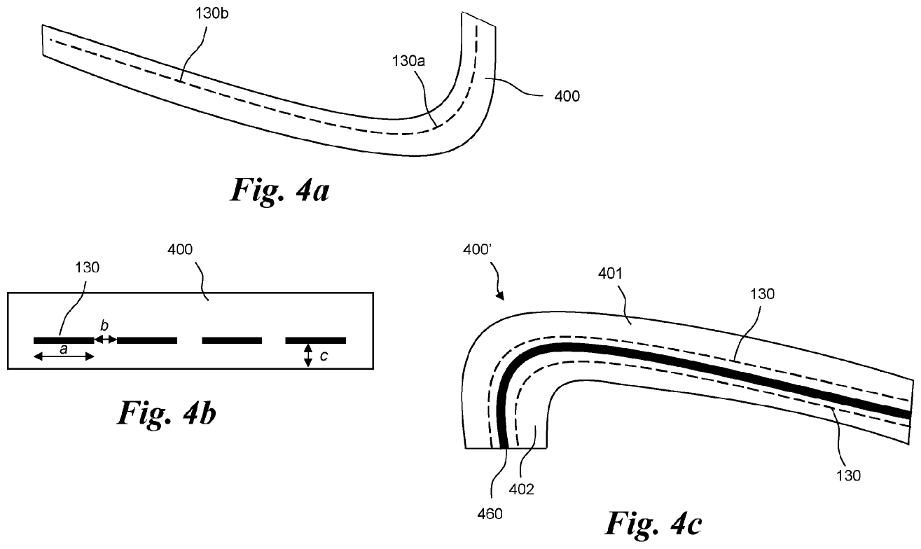

The flexible mold mat 100 should be capable of providing a mold 400 with smooth inner surfaces, see FIGS. 4a-c. This does not exclude that sharp edges and/or small structures may be present in the mold 400. However, for example surfaces with a curvature should be smooth and not be limited or marked by the shape of the flexible resonant electromagnetic structures 130. Molds produced according to prior art solution, with rigid resonant elements will not be able to provide a surface with a curvature that is smooth on a smaller scale, as such a surface will bear traces of the rigid resonant elements. The curved surface will in fact be made up by a plurality of surfaces corresponding to the shape of the rigid resonant elements, most likely plane surfaces. The flexible base material of the at least one layer 111 further puts constrains on the geometry of the mold 400, for example the positioning of an edge and/or size of smaller details. The flexible mold mat 100 according to the invention has uniform mechanical characteristics regardless of position on the surface, i.e., regardless of whether the flexibility is determined at a position on top of a flexible resonant electromagnetic structure 130 or at a position not having any flexible resonant electromagnetic structure 130 underneath. The mechanical characteristics of the flexible mold mat 100 may be described as being governed by the plurality of flexible layers 110 and not by the flexible resonant electromagnetic structures 130. This is according to the invention achieved by the resonant electromagnetic structures 130 being flexible in the same degree as the other parts of the flexible mold mat 100. According to the invention, each of the flexible resonant electromagnetic structures 130 has a stiffness that is equal to or less than the combined stiffness of the flexible layers 110 and the curable material 120, preferably each of the flexible resonant electromagnetic structures 130 has a stiffness that is at least 10%, and even more preferably a stiffness that is at least 20% lower than the combined stiffness of the flexible layers 110 and the curable material 120.

According to one embodiment of the invention, each of the flexible resonant electromagnetic structures 130 has a stiffness that is equal to or less than the flexible base material of the at least one layer 111, to which it is mounted on or embedded.

According to one embodiment of the invention, the flexible mold mat 100 is a multilayered structure comprising a plurality of layers 110, including at least one layer 111 comprising a flexible base material with the flexible resonant electromagnetic structures 130, and the curable material 120. In an embodiment, each of the flexible resonant electromagnetic structures 130 has a stiffness that is at least 10%, and even more preferably a stiffness that is at least 20% lower than the stiffness that an otherwise identical multilayered structure would have without the flexible resonant electromagnetic structures 130.

According to the embodiment of the invention, wherein the flexible resonant electromagnetic structures 130 are thin metal films, the thickness of the thin metal films will be dependent on the selected material (metal or alloy). For metals such as gold, silver and copper, the thickness of the flexible electromagnetic resonant structures 130 is in the order of 10-500 μm. Thickness of the flexible electromagnetic resonant structures 130 as used herein is preferably average thickness of a flexible electromagnetic resonant structure 130.

For instance, a flexible electromagnetic structure 130 in the form of a printed patch antenna of aluminum or an aluminum alloy may have a thickness in the order or 17.5 μm to 35 μm on a flexible base material as substrate with thickness in the range 50 μm to 5 mm. A conductive wire used for realizing the flexible resonant electromagnetic structures 130 is in the range of 50 μm to 500 μm diameter. According to one embodiment of the invention, the flexible resonant electromagnetic structures 130 are thin metal films and each have a thickness that is lower than 10% of the thickness of the flexible mold mat 100.

According to one embodiment, the flexible resonant electromagnetic structures 130 are patches of a conductive fabric and each have thicknesses that are lower than 30% of the thickness of the flexible mold mat 100.

According to one embodiment, each of the resonant electromagnetic structures 130 is in the form of a patch that may have an area in the range of 10 to 1000mm² . The resonant electromagnetic structures 130 when in form of patches may be in various shapes, including but not limited to rectangular, quadratic, polygonal, triangular, cross-shaped, circular and oval. A mixture of shapes could be envisaged. The resonant properties will depend on the shape and distribution of the flexible resonant electromagnetic structures 130. However, the skilled person will with the teachings of this invention have the tools to, for example, chose an appropriate frequency with a limited number of tests.

According to one embodiment of the invention, the flexible resonant electromagnetic structures 130 are the only conducting elements in the flexible mold mat 100.

According to one embodiment of the invention, the flexible resonant electromagnetic structures 130 are dielectric resonators 130′ of a material that is permeable to high-frequency electromagnetic radiation, see FIG. 1c. The dielectric resonators 130′ may typically extend a distance, h, in the thickness direction of the flexible mold mat 100, and may be a puck or flat cylinder as schematically illustrated in FIG. 1c. However, a large variety of shapes, included but not limited to, rectangular block, polygon, dome-shaped, triangular based and cross-shape based could be used. The dielectric resonators 130′ are placed in direct contact with the flexible base material. The dielectric resonators 130′ may comprises low loss ceramic materials, for example alumina (Al₂O₃), magnesium oxide (MgO), titanium oxide (TiO₂), compounds based on alkaline earth metals like Ba, Sr, Ca or Mg, with other compounds of titanates, tantalates/niobates, silicates and tungstates. Dielectric resonators 130′ made of such materials, will have typical dimensions of 1 to 100 mm in diameter.

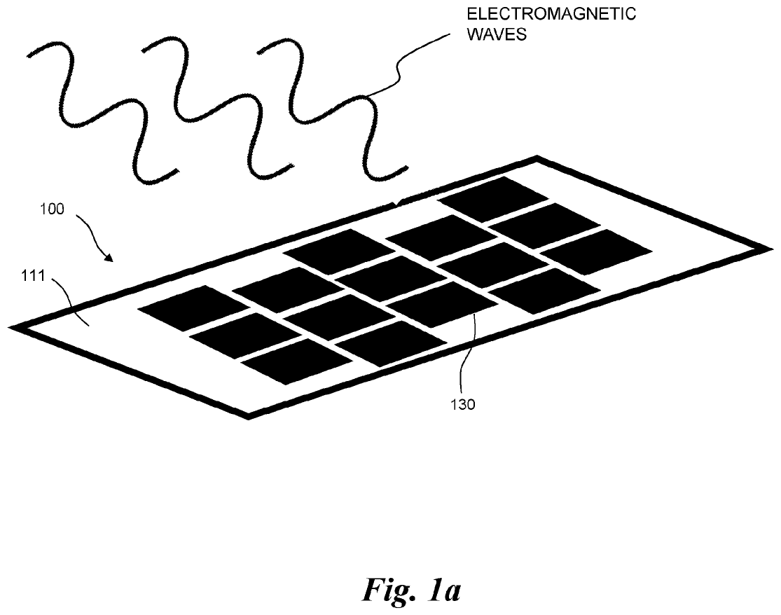

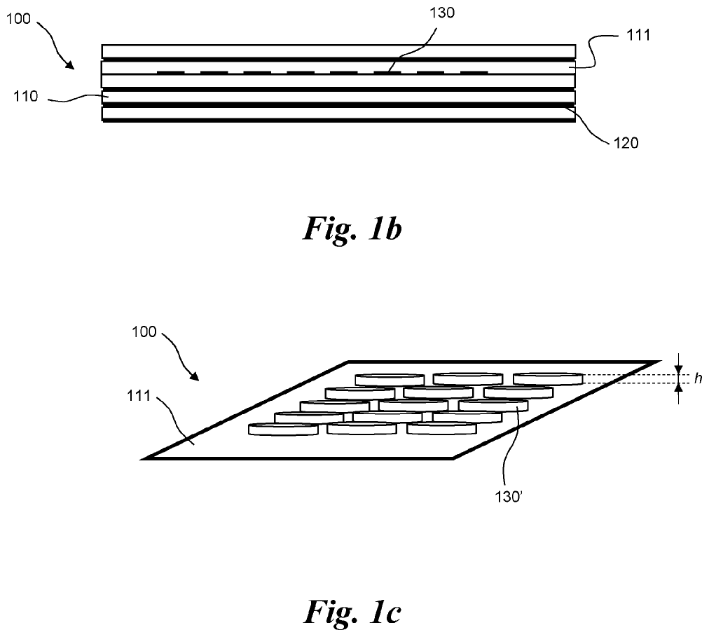

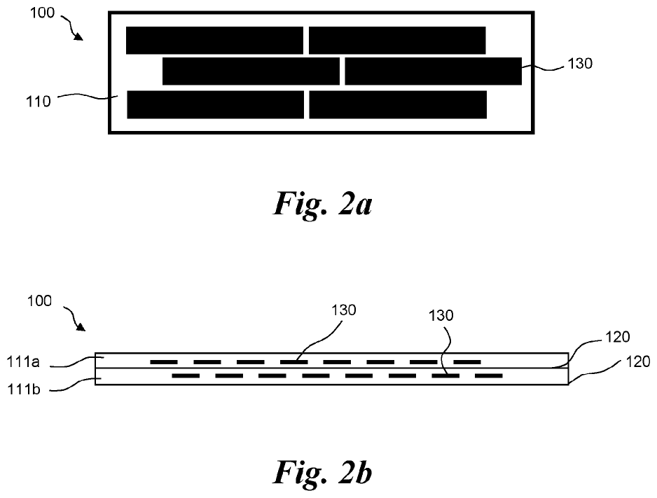

According to embodiments of the invention, schematically illustrated in FIGS. 2a-b, the flexible resonant electromagnetic structures 130 are provided in regular patterns, wherein each individual flexible resonant electromagnetic structure 130 is arranged to electromagnetically couple to neighboring flexible resonant electromagnetic structures 130 and thereby the resonance bandwidth is increased.

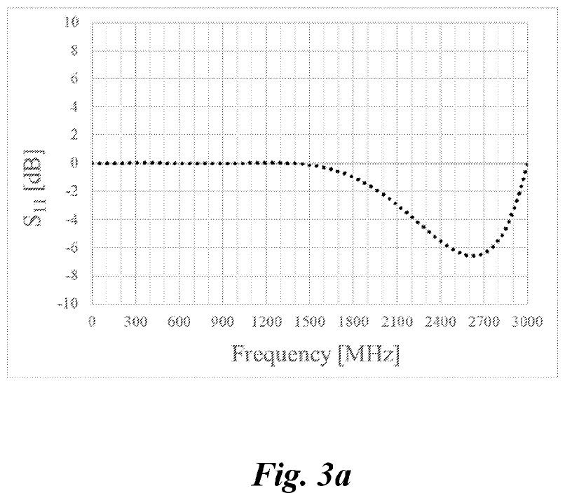

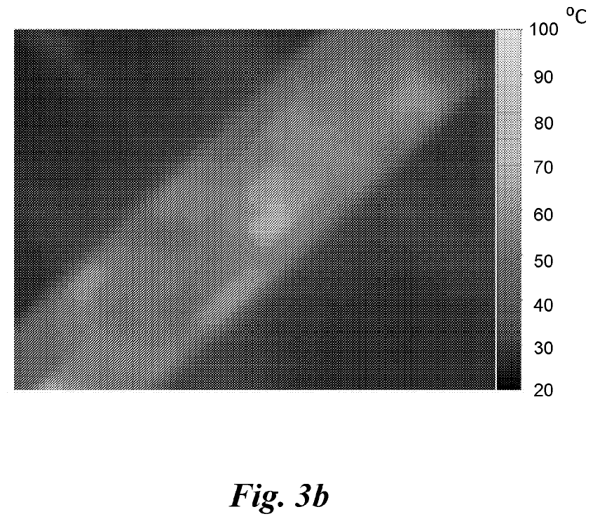

According to one embodiment, schematically illustrated in a top view in FIG. 2a, the flexible resonant electromagnetic structures 130 are arranged on the layer 111 in a regular 2D pattern. The distances between neighboring flexible resonant electromagnetic structures 130 is preferably in the order of 1-10 mm, which is suitable for the resonant electromagnetic structures resonant in a frequency range of 2.4-2.5 GHz. The resulting resonance spectra is illustrated in the graph of FIG. 3a, wherein the dotted line corresponds to the reflection coefficient, S11 of a single patch antenna, i.e., a flexible resonant electromagnetic structure 130, when probed separately.

According to one embodiment, schematically illustrated in a cross-sectional view in FIG. 2b, the resonant electromagnetic structures 130 are arranged in a 3D pattern. The 3D pattern may be realized by having two or more flexible base layers 111a, 111b in the flexible mold mat 100, each of the flexible base layers 111a, 111b provided with a plurality of flexible resonant electromagnetic structures 130, forming an upper pattern and a lower pattern of flexible resonant electromagnetic structures 130. The distances between neighboring flexible resonant electromagnetic structures 130 in the same plane, i.e., in the same base layer 111a, 111b, is in the order of 1 to 10 mm, and the distance between planes, i.e., between the base layers 111a, 111b, of the flexible resonant electromagnetic structures 130 is in the order of 1 to 10 mm.

FIG. 3b is an illustration showing that the 2D pattern of flexible resonant electromagnetic structures 130 according to one embodiment of the invention produces a sufficient heating and that the heating is uniform over a large area.

According to one aspect of the invention, a mold 400 is provided and schematically illustrated in FIG. 4a. Commonly, a mold 400 for producing a carbon fiber composite product 460 is not a flat surface, rather a curved surface or an even more complex geometry reflecting the object to be produced. The mold 400 may be produced using the mold mat 100 as described above, and having been cured or hardened. The mold 400 preferably has smooth surfaces with no trace of the positions of the flexible resonant electromagnetic structures 130 on the surface to enter in contact with the carbon fiber composites 460. Alternatively, according to one embodiment of the invention, the flexible resonant electromagnetic structures 130 are integrated into the mold 400, during the fabrication of the mold 400. This is made as a succession of layers, typically 8 to 18. The layers are placed in a negative mold and epoxy glue is provided to the negative mold, then it is cured and becomes hardened forming the positive mold 400.

In the mold 400, the flexible resonant electromagnetic structures 130 may typically be in the order of 25×25 mm, a, and be approximately 5 mm, b, apart, as schematically illustrated in FIG. 4b. The flexible resonant electromagnetic structures 130 are typically provided relatively close, in the order of 1.5 mm, c, to the surface of the mold 400 that will receive the fiber composite product 460 for molding.

The flexible resonant electromagnetic structures 130 may have individual shapes as given by the mold forming process. For a mold 400 designed for a less complex structure, for example a wing, the variation of the shape of the flexible resonant electromagnetic structures 130 may be rather small and, for example, only vary in one direction, for a wing probably mostly in a direction transverse to the elongated direction. For the production of a more complex object, for example a bicycle frame, the variations of the shape of the individual flexible resonant electromagnetic structures 130 will be large.

According to one embodiment, see FIG. 4a, the mold 400 has a plurality of flexible resonant electromagnetic structures 130, wherein at least a first flexible resonant electromagnetic structure 130a has a first curvature and at least a second flexible electromagnetic structure 130b has a second curvature with regards to the surface to receive the object to be molded, and wherein the first curvature differs from the second curvature. According to one embodiment, the mold 400 comprises at least a first flexible electromagnetic structure 130a that has a mean curvature that differs more than 10%, preferably more than 15% and even more preferably more than 20% from the mean curvature of at least a second flexible resonant electromagnetic structure 130b.

According to one embodiment, schematically illustrated in FIG. 4c, the mold 400′ comprises a lower mold part 401 and an upper mold part 402, each fabricated from a respective flexible mold mat 100. Both the lower mold part 401 and the upper mold part 402 comprises a plurality of flexible resonant electromagnetic structures 130 so that heat can be provided to the carbon fiber composite product 460 from both sides. In FIG. 4c, a wing shape structure is formed. The flexible mold mat 100 and the mold 400 according to the invention facilitate a production process of carbon fiber composite products 460 that utilizes electromagnetic heating of the carbon fiber composite product 460 as compared to the prior art autoclave-based technologies for convection heating, and represents one embodiment of a production method according to the invention.

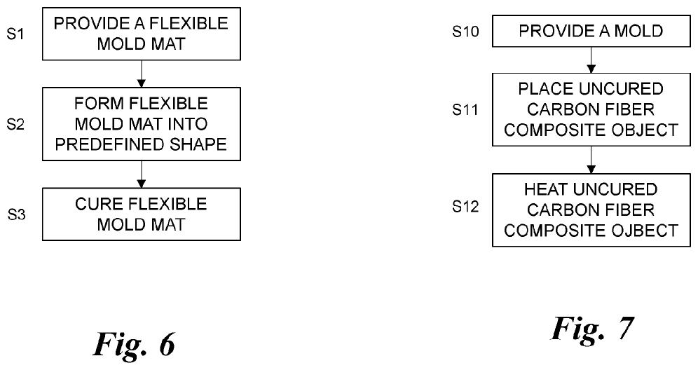

FIG. 6 is a flow chart illustrating a method of forming a mold 400. The method comprises providing, in step S1, a flexible mold mat 100 according to the present invention. The method also comprises forming, in step S2, the flexible mold mat 100 into a predefined shape and curing, in step S3, the flexible mold mat 100 thereby forming a rigid mold 400.

FIG. 7 is a flow chart illustrating a method of curing a carbon fiber composite object 460. The method comprises providing, in step S10, a mold 400 according to the invention. The method also comprises placing, in step S11, an uncured carbon fiber composite object 460 into the mold 400. The method further comprises heating, in step S12, the uncured carbon fiber composite object 460 by providing microwave radiation of a predetermined frequency from a microwave radiation source to the plurality of flexible resonant electromagnetic structures 130. The predetermined frequency and the characteristics of the plurality of flexible resonant electromagnetic structures 130 are matched so that the plurality of flexible resonant electromagnetic structures 130 generates heat, thereby curing the uncured carbon fiber composite object 460 to form a rigid carbon fiber composite object.

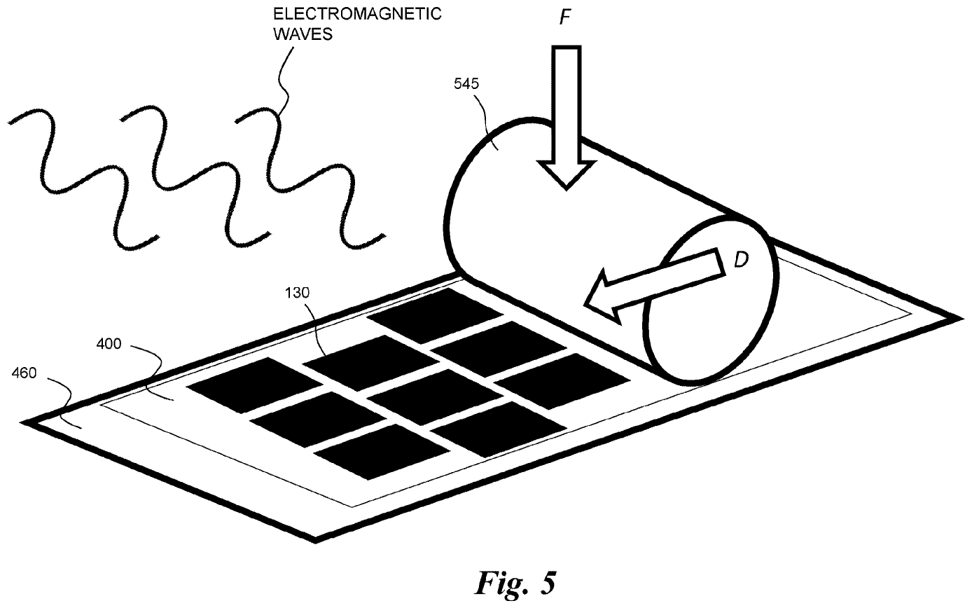

According to a particular embodiment of the invention, a production process for producing a carbon fiber composite product 460 is provided. The principles of the method according to the embodiment are illustrated in the FIG. 5, and comprises placing an intermediate, i.e., an uncured carbon fiber composite material 460 on top of a support surface. The method also comprises placing a mold 400 on top of the carbon fiber composite material 460. The method further comprises providing heat to a section of the carbon fiber composite material 460 by subjecting a corresponding section of the plurality of flexible resonant electromagnetic structures 130 to microwave radiation. The section represents a portion of all flexible resonant electromagnetic structures 130 present in the mold 400. The method further comprises providing pressure to the section of the carbon fiber composite material 460 that is or was heated. Pressure may be applied with a consolidation roll 545 pressing the carbon fiber composite material 460 towards the mold 400 with a predetermined force, indicated with F. The process direction is indicated with D. Alternatively, the carbon fiber composite material 460 is cooled in a step subsequent to the pressing step. Hence, the pressure provision can be performed simultaneously or following heating. In an embodiment, the method also comprises repeating the heating and pressing steps until the complete carbon fiber composite material 460 is cured. The carbon fiber composite material 460 is then cooled to form a final carbon fiber composite product. Typically, the heating and pressing steps are performed in one direction and covering the full width of the carbon fiber composite material or product.

According to a preferred embodiment of the invention, the consolidation roll 545 is provided with an electromagnetic source, typically within the consolidation roller 545. Thereby, a simultaneous localized heating and pressing action is achieved.

The method may comprise a step of cooling the carbon fiber composite material 460.

The method according to the invention is particularly useful for multi-directional and woven carbon fabrics, which are difficult to cure with microwaves otherwise. The method is described as stepwise. Alternatively, the heating and pressuring means are moved continuously and with the same speed in relation to the carbon fiber composite material 460.

The present invention can also be used in battery production to dry a battery slurry, also referred to electrolyte slurry. In such a production, a battery slurry can be deposited on substrates, typically in the form of thin metallic substrates, in the order of 5 to 10 μm in thickness, of copper (Cu) or aluminum (Al) foils to get a thin slurry coating, typically in the range of 150-200 μm. The battery slurry coating on the Cu or Al foil can then be dried using a mold 400 according to the invention to produce a battery electrode (Cu—anode, Al—cathode).

Battery slurries are mixtures of active material, conductive additives, and polymer adjuvants/binders in a solvent.

Solvents could be water, aqueous solvents or non-aqueous solvents. Illustrative, but non-limiting, examples of such solvents include N-methyl-2-pyrrolidone (NMP), dimethyl carbonate (DMC), ethylene carbonate (EC), propylene carbonate (PC), water and mixtures thereof.

NMP is a polar aprotic solvent commonly used in the manufacturing of lithium-ion battery slurries. It is effective in dissolving various polymers and facilitating the formation of a homogenous slurry. DMC is another polar aprotic solvent used in battery slurries, especially in the context of lithium-ion batteries. It is considered less toxic than some alternatives and is used as a co-solvent with other solvents. EC is a high-permittivity solvent often used in combination with other solvents. It helps improve the conductivity of the electrolyte and promotes better electrode/electrolyte interactions. PC is a popular solvent in lithium-ion battery slurries. Like EC, it is used to enhance the conductivity of the electrolyte and improve the overall performance of the battery. In some cases, water is used as a solvent, especially in the development of aqueous battery technologies. Water-based slurries are more environmentally friendly.

While graphite is a commonly used conductive additive in battery slurries, there are other conductive materials that can be employed in battery electrode formulations. The choice of conductive additive often depends on the specific type of battery and its intended application. Illustrative, but non-limiting, examples of conductive additives for the battery slurry include graphite, carbon black (CB), carbon nanotubes (CNTs), graphene, conductive polymers, metal nanoparticles, metal oxides, carbon fibers and combinations thereof. Similar to graphite, carbon black is a form of elemental carbon. It has high conductivity and is often used as a conductive additive in battery slurries, particularly in lithium-ion batteries. CNTs are cylindrical structures composed of carbon atoms. They offer excellent electrical conductivity and high surface area, making them suitable for improving the conductivity and mechanical properties of battery electrodes. Graphene is a single layer of carbon atoms arranged in a hexagonal lattice. It possesses exceptional electrical conductivity and mechanical strength. Graphene-based materials are being explored for various battery applications. Some conductive polymers, such as polyaniline or polypyrrole, can be used as alternatives to traditional carbon-based materials. These polymers can provide good electrical conductivity while offering flexibility. Nanoscale metal particles, such as silver or gold nanoparticles, can be used as conductive additives. These materials can enhance electrical conductivity and may have unique properties beneficial for specific battery applications. Certain metal oxides, like manganese dioxide or titanium oxide, can also exhibit good electrical conductivity and are used as conductive additives in battery electrodes. Carbon fibers provide good electrical conductivity and mechanical strength. They can be used to reinforce the structure of battery electrodes, especially in applications where mechanical stability is crucial.

The primary purposes of incorporating carbon-based materials into battery slurries include conductivity, structural support, surface area and enhanced performance. Carbon-based materials are excellent conductors of electricity. They enhance the electrical conductivity of battery electrodes, facilitating the movement of electrons and ions within the electrode materials. Some carbon-based materials, such as carbon fibers, provide structural support to battery electrodes. This is especially important in applications where mechanical stability and durability are crucial. Materials like activated carbon and graphene have large surface areas, providing more sites for ions to attach and facilitating higher energy storage capacities in certain types of batteries, such as supercapacitors. The incorporation of carbon-based materials can also improve the overall performance of batteries, including energy density, cycling stability, and rate capability.

Polymer adjuvants, also known as binders, are important components in battery slurries. They serve to enhance the structural integrity of the electrodes and ensure effective adhesion among the various active and conductive materials. Illustrative, but non-limiting, examples of binders that can be used in battery slurries include polyvinylidene fluoride (PVDF), polyacrylic acid (PAA), carboxymethyl cellulose (CMC), styrene-butadiene rubber (SBR), and combinations and derivatives thereof. PVDF is a common polymer binder used in battery electrodes, especially in lithium-ion batteries. It provides good adhesion and mechanical strength to electrode materials. PAA and its derivatives are used as binders in certain battery formulations. They contribute to the binding of active materials and conductive additives in the slurry. CMC is a water-soluble polymer often used as a binder in aqueous battery slurries. It helps improve the homogeneity of the slurry and enhances the adhesion of materials in the electrode. SBR is a synthetic rubber that is used as a binder in electrodes, particularly in lead-acid batteries. It provides good adhesion and flexibility.

The purpose of polymer adjuvants in battery slurries includes binder function, adhesion, flexibility, and electrolyte management. The primary purpose of polymer adjuvants is to act as a binder, holding together the various components of the battery electrode, including active materials, conductive additives, and current collectors. Polymer adjuvants enhance the adhesion between different materials, ensuring a strong bond within the electrode structure. This is crucial for maintaining the structural integrity of the electrode during repeated charge and discharge cycles. Some polymers, like PVDF, contribute to the flexibility of the electrode, accommodating the expansion and contraction of materials during electrochemical processes. Certain polymer adjuvants may interact with the electrolyte, contributing to the overall stability and performance of the battery.

The material that intervenes the electrode reaction of a battery is denoted the active material. Generally, cathode active materials (CAM) are typically metal oxides. The most common cathode materials used in lithium-ion batteries include lithium cobalt oxide (LiCoO₂), lithium manganese oxide (LiMn₂O4), lithium iron phosphate (LiFePO₄ or LFP), and lithium nickel manganese cobalt oxide (LiNiMnCoO₂ or NMC). Anode active materials (AAM), on the other hand, are generally made from carbon-based materials like graphite, silicon, or a combination of both. Graphite is the most commonly used anode material due to its high electrical conductivity, low cost, and stable structure. Silicon anodes offer higher energy density but face challenges in terms of volume expansion and shorter cycle life. Some anode iterations will also ‘dope’ graphite anodes with a small amount of silicon to improve performance characteristics and energy density.

The battery slurry may also comprise other components than the active material, conductive additive, polymer adjuvant or binder and solvent. Illustrative, but non-limiting, examples of such additional, optional components include surfactants, salts and plasticizers.

Surfactants may be added to improve the wetting properties of the battery slurry, ensuring uniform coating on the electrode foils. Salts, and in particular lithium salts for lithium-ion batteries, may be included to enhance ionic conductivity of the electrolyte. Plasticizers may be added to improve the flexibility of the dried electrode.

The process of depositing the battery slurry onto an electrode foil is an important step in the manufacturing of battery electrodes. This process involves applying a mixture of active materials, conductive additives, and binders in a solvent, i.e., the battery slurry, onto the surface of a conductive foil, typically made of materials like aluminum or copper. The deposited battery slurry forms an electrode structure, and its characteristics influence the performance of the battery.

In a typical production process, the various components of the battery slurry, i.e., the active materials, such as LiCoO₂ or graphite, conductive additive, such as carbon black or carbon nanotubes, and polymer binders, such as PVDF or CMC, are mixed together with solvent to create a homogenous slurry.

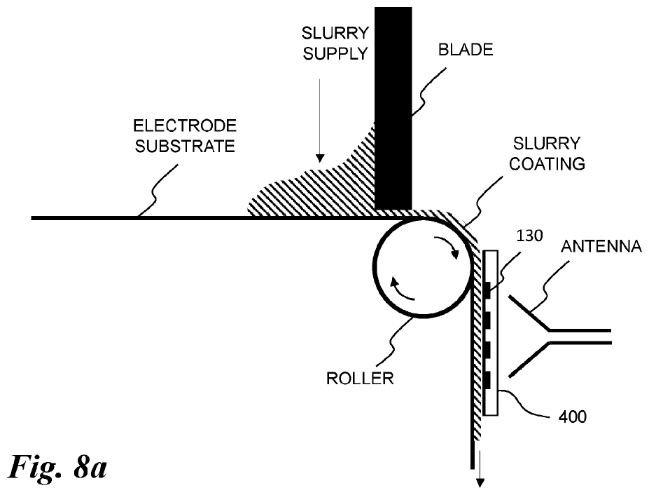

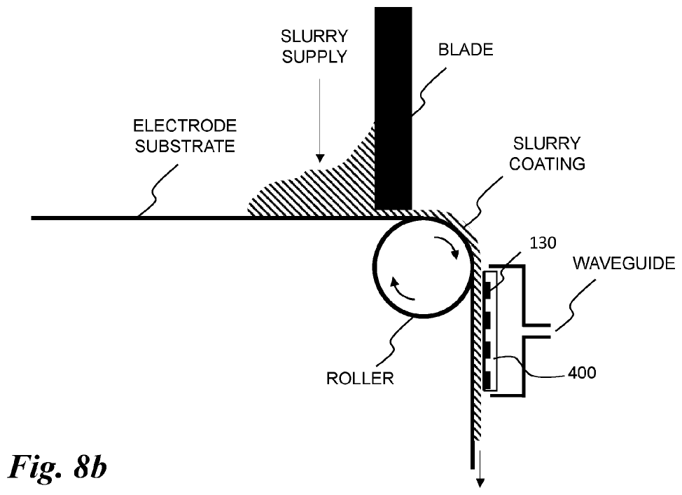

The prepared battery slurry is then coated onto a conductive foil as shown in FIGS. 8a and 8b. This is typically done using a coating technique, such as doctor-blading, tape-casting, or slot-die coating. In doctor-blading, a blade spreads the battery slurry onto the conductive foil, creating a uniform layer. Tape-casting involves applying the battery slurry to a moving carrier tape, and slot-die coating uses a die to precisely control the thickness of the deposited battery slurry.

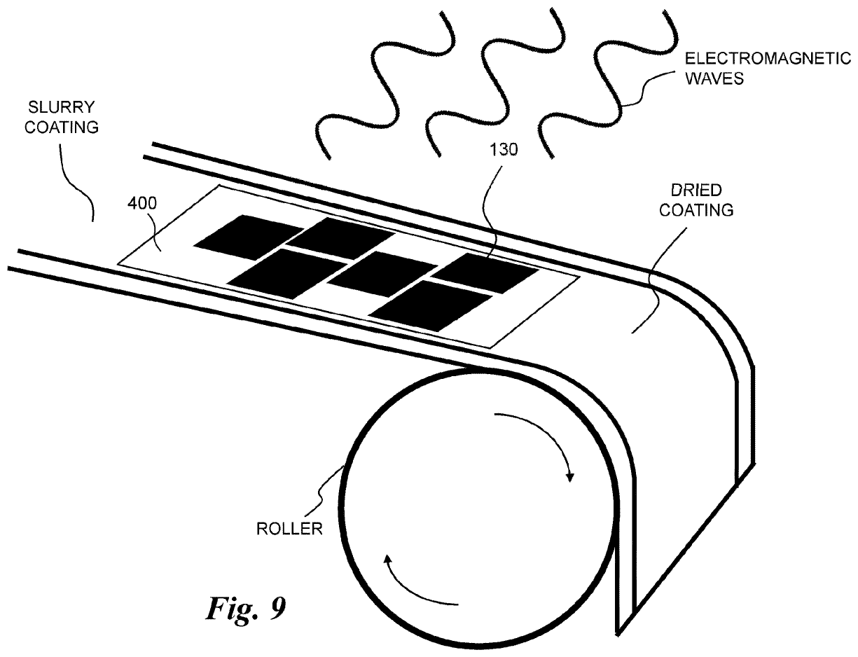

After deposition, the coated foil pass through a drying or curing process to remove the solvent. This step forms a solid and stable electrode structure. Drying can be performed using a mold 400 according to the present invention as shown in FIGS. 8a, 8b and 9. The mold 400 can then be used to heat the battery slurry with microwaves. The drying time was thereby significantly reduced as compared to other drying methods. Further, the energy used in the drying process was low.

For instance, the energy and time needed to reach 120° C. for a battery slurry sample of 1 g was 160 Wh/kg and 14 s. After reaching 120° C., much less power and, thus, energy is needed to maintain the temperature. Hence, maintaining the temperature at 120° C. merely required 220 Wh/kg per minute. The mass of the battery slurry was, due to drying reduced by 45 % in 5 min needing only 2 Wh for 1 g of battery slurry.

In some cases, the dried electrode may undergo an optional calendering process. Calendering involves passing the electrode through rollers to compact and improve the density and mechanical properties of the electrode. The coated and dried foils are then cut into the desired shapes and sizes. Multiple layers of anode and cathode electrodes are then stacked alternately with separator layers to form a complete battery cell.

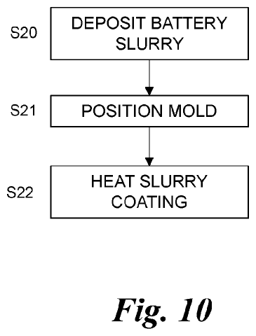

The present invention therefore relates to a method of producing a battery electrode, see FIG. 10. The method comprises depositing, in step S20, a battery slurry comprising an active material, a conductive additive, a polymer adjuvant and a solvent onto an electrode foil to form a slurry coating. The method also comprises positioning, in step S21, a mold 400 according to the invention in proximity with the slurry coating and heating, in step S22, the slurry coating on the electrode foil to remove solvent from the slurry coating by providing microwave radiation of a predetermined frequency from a microwave radiation source to the plurality of flexible resonant electromagnetic structures 130. The predetermined frequency and the characteristics of the plurality of flexible resonant electromagnetic structures 130 are matched so that the plurality of flexible resonant electromagnetic structures 130 generates heat in the slurry coating, thereby drying the slurry coating on the electrode foil to form a battery electrode.

The mold 400 is positioned in proximity with the slurry to couple electromagnetic energy in the slurry. Hence, the mold 400 is positioned in proximity with, but not in contact with, the slurry as shown in FIGS. 8a and 8b.

FIG. 8a illustrates an antenna as the microwave radiation source, whereas in FIG. 8b, the microwave radiation source is in the form of a waveguide. The antenna or waveguide then provides the electromagnetic coupling with the flexible resonant electromagnetic structures 130 of the mold 400.

The embodiments described above are to be understood as illustrative examples of the present invention. It will be understood that those skilled in the art that various modifications, combinations and changes may be made to the embodiments. In particular, different part solutions in the different embodiments can be combined in other configurations, where technically possible.

1. A flexible mold mat comprising:
a plurality of layers; and
a curable substance, wherein at least one layer of the plurality of layers comprises:
a flexible base material; and
a plurality of flexible resonant electromagnetic structures positioned on the flexible base material, wherein the flexible resonant electromagnetic structures are electrically insulated from each other.

2. The flexible mold mat according to claim 1, wherein the flexible resonant electromagnetic structures each has a thickness in a range of 0.1% to 10% of the thickness of the flexible mold mat

3. The flexible mold mat according to claim 1, wherein the flexible resonant electromagnetic structures are patches of a conductive material, and wherein the at least one layer comprising the patches is non-conducting.

4. The flexible mold mat according to claim 1, wherein the flexible resonant electromagnetic structures have a stiffness that is less than 1.5 times the stiffness of the flexible base material.

5. The flexible mold mat according to claim 4, wherein the plurality of layers of the flexible mold mat forms a multilayered structure, and wherein the flexible resonant electromagnetic structures each has a stiffness that is less than 1.3 times the stiffness of the multilayered structure.

6. The flexible mold mat according to claim 1, wherein the flexible resonant electromagnetic structures comprise a carbon fiber material, and wherein the carbon fiber material is the main constituent of the flexible resonant electromagnetic structures,

7. The flexible mold mat according to claim 1, wherein the flexible resonant electromagnetic structures are thin metal films or metallic wires.

8. The flexible mold mat according to claim 6, wherein the conductivity of the flexible resonant electromagnetic structures is above 1 S/m.

9. The flexible mold mat according to claim 1, wherein the flexible resonant electromagnetic structures are dielectric resonators of a material that is permeable to high-frequency electromagnetic radiation, and wherein the dielectric resonators are placed in direct contact with the flexible base material.

10. The flexible mold mat according to claim 1, wherein the flexible resonant electromagnetic structures are arranged in a 2D regular pattern.

11. The flexible mold mat according to claim 10, wherein the 2D regular pattern is adapted to be used in a frequency range of 2.4-2.5 GHZ and individual flexible resonant electromagnetic structures of the plurality of flexible resonant electromagnetic structures are in the later size of 30 mm with a thickness of 17.5 μm or 35 μm the 2D regular pattern is a succession of gaps and rectangular patch structures.

12. The flexible mold mat according to claim 10, wherein the plurality of layers of the flexible mold mat form a multilayered structure, and wherein the 2D regular pattern of the flexible resonant electromagnetic structures are placed on both the upper half and bottom half of the multilayered structure.

13. The flexible mold mat according to claim 1, wherein the flexible resonant electromagnetic structures are arranged in a 3D regular pattern.

14. A mold for heating and curing a carbon fiber composite object, the mold comprising:
a plurality of flexible resonant electromagnetic structures; and
the flexible mold mat according to claim 1.

15. A method of forming a mold comprising the steps of:
providing the flexible mold mat (100) according to claim 1;
forming the flexible mold mat into a predefined shape; and
curing the flexible mold mat thereby forming a rigid mold.

16. A method of curing a carbon fiber composite object comprising the steps of:
providing the mold according to claim 14;
placing an uncured carbon fiber composite object into the mold; and
heating the uncured carbon fiber composite object by providing microwave radiation of a predetermined frequency from a microwave radiation source to the plurality of flexible resonant electromagnetic structures, wherein the predetermined frequency and the characteristics of the plurality of flexible resonant electromagnetic structures are matched so that the plurality of flexible resonant electromagnetic structures generates heat, thereby curing the uncured carbon fiber composite object to form a rigid carbon fiber composite object.

17. The method of curing a carbon fiber composite object according to claim 16, wherein the uncured carbon fiber composite object is cured in a continuous process by continuously activating portions of the plurality of flexible resonant electromagnetic structures by microwave radiation from the microwave radiation source.

18. The method of curing a carbon fiber composite object according to claims 16, further comprising applying pressure to the heated carbon fiber composite object.

19. The method of curing a carbon fiber composite object according to claim 18, wherein the step of applying pressure includes a consolidation roller which is arranged to pressure the heated carbon fiber composite object with a predetermined force and to move over the heated carbon fiber composite object in a predetermined direction.

20. The method of curing a carbon fiber composite object according to claim 19, wherein the consolidation roller comprises the microwave radiation source so that a portion of the plurality of flexible resonant electromagnetic structures are activated so that the uncured carbon fiber composite object is simultaneously exposed to localized heat and pressure from the consolidation roller.

21. A device for curing a carbon fiber composite object, the device comprises:
the mold according to claim 14; and
a consolidation roller comprising a microwave radiation source and arranged to simultaneously provide localized pressure to the carbon fiber composite object and localized heat by the microwave radiation source activating a portion of the plurality of flexible resonant electromagnetic structures provided in the mold.

22. A method for producing a battery electrode comprising the steps of:
depositing a battery slurry comprising an active material, a conductive additive, a polymer adjuvant and a solvent onto an electrode foil to form a slurry coating;
positioning the mold according to claim 14 in proximity with the slurry coating; and
heating the slurry coating on the electrode foil to remove solvent from the slurry coating by providing microwave radiation of a predetermined frequency from a microwave radiation source to the plurality of flexible resonant electromagnetic structures, wherein the predetermined frequency and the characteristics of the plurality of flexible resonant electromagnetic structures are matched so that the plurality of flexible resonant electromagnetic structures generates heat in the slurry coating, thereby drying the slurry coating on the electrode foil to form a battery electrode.
